(19) United States
(12) Patent Application Publication
(10) Pub. No.: US 2018/0157137 A1
(43) Pub. Date: Jun. 7, 2018

(54) AN ARRAY SUBSTRATE AND LIQUID CRYSTAL DISPLAY PANEL

(71) Applicant: Shenzhen China Star Optoelectronics Technology Co. Ltd., Shenzhen (CN)

(72) Inventor: Jinjie WANG, Shenzhen (CN)

(73) Assignee: Shenzhen China Star Optoelectronics Technology Co. Ltd., Shenzhen (CN)

(21) Appl. No.: 14/897,745

(22) PCT Filed: Oct. 28, 2015
(86) PCT No.: PCT/CN2015/093098

§ 371 Date: Dec. 27, 2017

(30) Foreign Application Priority Data
Sep. 23, 2015 (CN) 201510612754.7

(51) Int. Cl. G02F 1/1362; G02F 1/1337; G02F 1/1343

(52) U.S. Cl. CPC G02F 1/136286; G02F 1/1337; G02F 2201/123; G02F 1/13439; G02F 2001/136222; G02F 1/134336

(57) ABSTRACT

Provided is an array substrate and a liquid crystal display panel. The array substrate comprises a plurality of data lines, a plurality of scan lines, and a plurality of sub-pixel units formed by the plurality of data lines and the plurality of scan lines in a staggered arrangement, two adjacent sub-pixel units forming a pixel module. The pixel module comprises: a color barrier layer, including a first color barrier unit and a second color barrier unit respectively formed in the two adjacent sub-pixel units, a color barrier interface between the first color barrier unit and the second color barrier unit being formed above the data lines; a pixel electrode layer, including a first pixel electrode and a second pixel electrode that are formed on the color barrier layer, the first pixel electrode and the second pixel electrode respectively corresponding to the first color barrier unit and the second color barrier unit; and a projection formed directly above the color barrier interface. The array substrate is capable of reducing or even eliminating dark lines or the dark areas appearing in the display of an existing array substrate.

### CROSS-REFERENCE TO RELATED APPLICATIONS

The present application claims the priority of Chinese patent application CN 201510612754.7, entitled “An array substrate and liquid crystal display panel” and filed on Sep. 23, 2015, the entirety of which is incorporated herein by reference.

### FIELD OF THE INVENTION

The present disclosure relates to the field of liquid crystal display, and in particular, to an array substrate and a liquid crystal display panel.

### BACKGROUND OF THE INVENTION

Liquid crystal display devices, with the advantages of low radiation, small sizes, low power consumption, and the like, have been gradually replacing traditional cathode ray tube display devices and are being widely used in flat panel TVs, personal computers, mobile display panels, and other products.

A conventional liquid crystal display panel mainly includes a three-layer structure, respectively a thin film transistor (TFT) array substrate for controlling the intensity of a liquid crystal electric field, a liquid crystal layer, and a color filter (CF) substrate. A Color filter On Array (COA) substrate is a technique in which a color barrier layer in the CF substrate is provided in the TFT array substrate. The COA substrate can reduce coupling between a pixel electrode and a metal wire, so as to reduce signal delay in the metal wire.

However, in display of an existing COA substrate, dark lines or even large dark areas easily occur, thereby greatly preventing promotion and use of the COA substrate.

### SUMMARY OF THE INVENTION

The technical problem to be solved by the present disclosure is how to reduce dark lines or even large dark areas easily appearing in display of an existing COA substrate. In order to solve the above problem, the present disclosure first provides an array substrate in one embodiment thereof, comprising: a plurality of data lines, a plurality of scan lines, and a plurality of sub-pixel units formed by the plurality of data lines and the plurality of scan lines in a staggered arrangement, two adjacent sub-pixel units forming a pixel module, which comprises:
a color barrier layer, including a first color barrier unit and a second color barrier unit respectively formed in the two adjacent sub-pixel units, a color barrier interface between the first color barrier unit and the second color barrier unit being formed above the data lines;
a pixel electrode layer, including a first pixel electrode and a second pixel electrode that are formed on the color barrier layer, the first pixel electrode and the second pixel electrode respectively corresponding to the first color barrier unit and the second color barrier unit; and
a projection formed directly above the color barrier interface, so as to effect a reliable alignment of a liquid crystal close to the projection.

According to one embodiment of the present disclosure, the first pixel electrode comprises:
a first main electrode and a second main electrode, wherein the first main electrode is parallel and close to a first side of the first sub-pixel unit, and the second main electrode is perpendicular to the first main electrode, and
a plurality of branch electrodes, wherein one end of each of the branch electrodes is connected to at least one of the first main electrode and the second main electrode.

According to one embodiment of the present disclosure, the first main electrode and the second main electrode divide the pixel electrode layer into a plurality of display regions and a plurality of branch electrodes located in a same display region are parallel to each other.

According to one embodiment of the present disclosure, the first pixel electrode and the second pixel electrode are symmetrical with respect to the projection.

According to one embodiment of the present disclosure, the projection has a greater height than the pixel electrode layer.

According to one embodiment of the present disclosure, the projection has a different color from the first color barrier unit and the second color barrier unit.

According to one embodiment of the present disclosure, the projection is in the shape of a strip and parallel with the data lines.

According to one embodiment of the present disclosure, the first color barrier unit and the second color barrier unit partially overlap each other above the data lines.

According to one embodiment of the present disclosure, the first pixel electrode and/or the second pixel electrode are flexible electrodes.

The present disclosure further provides a liquid crystal display panel, comprising the array substrate according to any one of the above embodiments.

According to the array substrate provided in the present disclosure, the projection can be arranged to physically stabilize a tilt angle of a liquid crystal around the projection, so as to reduce or even eliminate the dark lines or dark areas appearing in the display of an existing array substrate. The effects of visual experience can thus be improved.

Other features and advantages of the present disclosure will be further explained in the following description, and partly become self-evident therefrom, or be understood through implementation of the present disclosure. The objectives and advantages of the present disclosure will be achieved through the structure specifically pointed out in the description, claims, and the accompanying drawings.

### BRIEF DESCRIPTION OF THE DRAWINGS

In order to explain the technical solution of the embodiments of the present disclosure or the technical solution in the prior art in a clearer manner, the accompanying drawings used in illustrating the prior art or the embodiments of the present disclosure are briefly introduced as follows, in which:

FIG. 1 schematically shows a partial structure of an array substrate in the prior art;

FIG. 2 is a partial cross-section view of the array substrate shown in FIG. 1;

FIG. 3 schematically shows a partial structure of an array substrate according to one embodiment of the present disclosure;

FIG. 4 is a partial cross-section view of the array substrate shown in FIG. 3; and

FIG. 5 is a partial cross-section view of an array substrate according to another embodiment of the present disclosure.

### DETAILED DESCRIPTION OF THE EMBODIMENTS

The present disclosure will be explained in detail with reference to the embodiments and the accompanying drawings in the following, whereby it can be fully understood how to solve the technical problem by the technical means according to the present disclosure and achieve the technical effects thereof, and thus the technical solution according to the present disclosure can be implemented. It is important to note that as long as there is no conflict, all the technical features mentioned in all the embodiments may be combined together in any manner, and the technical solutions obtained therefrom all fall within the scope of the present disclosure.

Meanwhile, various specific details are expounded in the following to provide a thorough understanding of the embodiments of the present disclosure. However, it is obvious for a person skilled in the art that, the present disclosure can be implemented through other specific details or in other specific manners than those described herein.

With the development of display technologies, curved liquid crystal display devices begin to appear in people's vision. Curved liquid crystal display devices have become increasingly popular among consumers thanks to a better effect of visual experience thereof. Currently, in a manufacturing procedure of a curved liquid crystal display device, a liquid crystal display panel is usually formed into a planar structure first, followed by a bending treatment performed on the liquid crystal display panel in a planar structure. The curved liquid crystal display panel can thus be obtained.

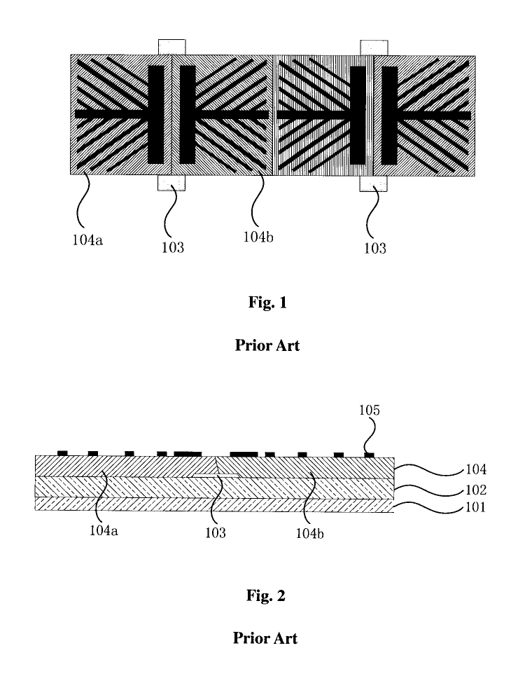

FIGS. 1 and 2 schematically show a partial structure of an array substrate in a liquid crystal display panel in the prior art, and a corresponding cross-section view thereof, respectively.

As shown in FIGS. 1 and 2, the existing array substrate includes a substrate 101, a passivation layer 102, a data line 103, a color barrier layer 104, and a pixel electrode layer 105. Therein, the passivation layer 102 is formed on the substrate 101, and the data line 103 is formed on the passivation layer 102. The color barrier layer 104 is formed on the passivation layer 102 and the data line 103. FIG. 2 shows two sub-pixel units, and correspondingly, the color barrier layer 104 includes a first color barrier unit 104a and a second color barrier unit 104b. Therein, an interface between the first color barrier unit 104a and the second color barrier unit 104b is located directly above the data line 103.

Correspondingly, the pixel electrode layer 105 includes a first pixel electrode 105a and a second pixel electrode 105b. Each of these two pixel electrodes includes a first main electrode, a second main electrode, and a plurality of branch electrodes, wherein the main electrodes of the two pixel electrodes are arranged opposite to each other.

While a liquid crystal display panel is being bended, since the array substrate in the liquid crystal display panel is based on a center of the panel, the array substrate will be gradually subject to a relative displacement in a horizontal direction along a left side or a right side, thus causing a relative displacement of the first main electrode (i.e., an electrode parallel to the data line 103) of the pixel electrode of the array substrate. This further leads to variation in an electric field, thereby generating dark lines or even dark areas in a vicinity of the main electrode in the sub-pixel electrode of the curved liquid crystal display device.

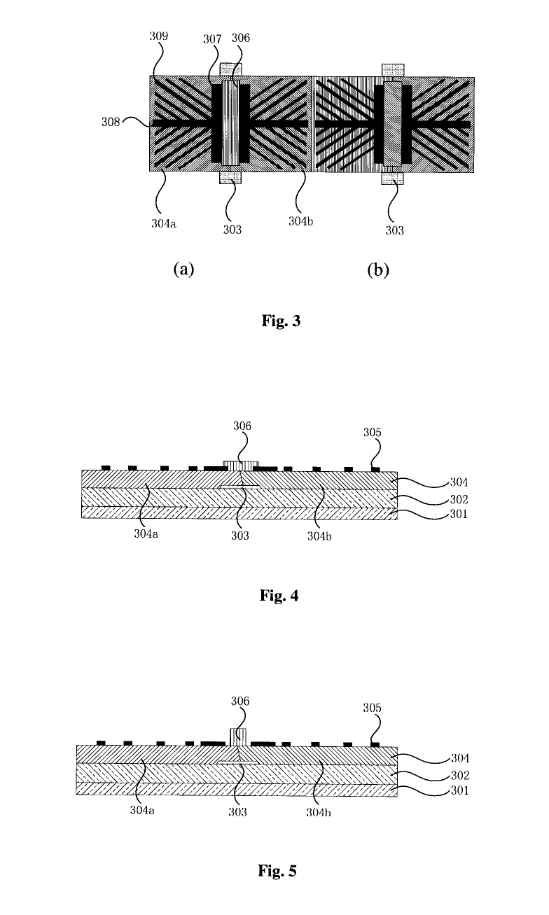

In view of the above-mentioned problem of the existing array substrate, the present embodiment provides a new array substrate, comprising a plurality of data lines, a plurality of scan lines, and a plurality of sub-pixel units formed by the data lines and the scan lines in a staggered arrangement, wherein two adjacent sub-pixel units form one pixel module. FIGS. 3 and 4 schematically show the structure of two adjacent pixel modules in the array substrate and a cross-section view of one of the pixel modules, respectively.

In the embodiment as shown in FIGS. 3 and 4, the pixel module includes a substrate 301, a passivation layer 302, a data line 303, a color barrier layer 304, a pixel electrode layer 305, and a projection 306. The passivation layer 302 is formed on the substrate 301, and the data line 303 is formed on the passivation layer 302. The color barrier layer 304 is formed on the passivation layer 302 and the data line 303. In the present embodiment, the substrate 301 is preferably a glass substrate. Of course, in other embodiments of the present disclosure, the substrate 301 can also be realized with other suitable materials (such as light-transmissive resins). The present disclosure is not limited thereto.

The color barrier layer 304 includes a first color barrier unit 304a and a second color barrier unit 304b, corresponding to two different sub-pixel units, respectively. In the present embodiment, the two color barrier units have different colors. For example, when the first color barrier unit 304a is red, the second color barrier unit 304b will be green or blue. As shown in FIG. 4, a color barrier interface between the first color barrier unit 304a and the second color barrier unit 304b is located directly above the data line 303. In the present embodiment, the color barrier interface between the first color barrier unit 304a and the second color barrier unit 304b is not perpendicular to the data line 303, but forms a certain tilt angle with the data line 303. Thus, the first color barrier unit 304a and the second color barrier unit 304b partially overlap each other above the data line 303.

It should be noted that in other embodiments of the present disclosure, the tilt angle formed between the data line 303 and the color barrier interface of the first color barrier unit 304a and the second color barrier unit 304b can be adjusted in size according to different requirements. It can be either an acute angle as shown in FIG. 4, an obtuse angle, or a right angle. The present disclosure is not limited thereto.

The pixel electrode layer 305 is formed on the color barrier layer 304, and includes pixel electrodes corresponding to different sub-pixel units. In the present embodiment, the pixel electrodes in the sub-pixel units are all flexible electrodes, and can be effectively used in a curved liquid crystal display panel. In the embodiment as shown in FIG. 3, the pixel electrodes of the sub-pixel units have a same structure. Therefore, for the sake of convenient description, the first pixel electrode corresponding to the first sub-pixel unit will be used as an example to further explain the structure of the array substrate provided in the present embodiment.

In the embodiment as shown in FIG. 3, the first pixel electrode includes a first main electrode 307, a second main electrode 308, and a plurality of branch electrodes 309. Therein, the first main electrode 307 is parallel and close to a first side (i.e., a side located above the data line 303) of the first sub-pixel unit. The second main electrode 308 is perpendicular to the first main electrode 307, and has an end preferably connected to a midpoint of the first main electrode 307, so as to form a T-shaped structure.

One end of each of the branch electrodes 309 is connected to at least one of the first main electrode 307 and the second main electrode 308. The first main electrode 307 and the second main electrode 308 divide the first sub-pixel unit into two display regions. These branch electrodes 309 are located in the two display regions, respectively. Therein, it is preferred that the branch electrodes 309 in a same display region are parallel to each other and equally spaced from each other. Of course, in other embodiments of the present disclosure, the branch electrodes 309 in the same display region can also be arranged in other reasonable manners (e.g., parallel to but unequally spaced from each other, or non-parallel to each other). The present disclosure is not limited thereto likewise.

In one and a same pixel module, the pixel electrodes corresponding to two sub-pixel units are preferably symmetrical with respect to a center vertical plane of the data line 303. That is, the first pixel electrode and the second pixel electrode are symmetrical with respect to the center vertical plane of the data line 303.

It should be noted that, in other embodiments of the present disclosure, the first pixel electrode and the second pixel electrode can be arranged in an asymmetrical manner. The present disclosure is not limited thereto.

The protrusion 306 is formed between the first pixel electrode and the second pixel electrode and located directly above the color barrier interface of the first color barrier unit 304a and the second color barrier unit 304b (also directly above the data line 303). Thus, the first pixel electrode and the second pixel electrode are also symmetrical with respect to the projection 306. In the present embodiment, the projection 306 preferably covers a portion of the first pixel electrode and the second pixel electrode.

Of course, in other embodiments of the present disclosure, as shown in FIG. 5, the projection 306 may not cover the first pixel electrode and/or the second pixel electrode. The present disclosure is not limited thereto.

In the present embodiment, the projection 306 has a different color from the first color barrier unit and the second color barrier unit. That is, when the first color barrier unit and second color barrier unit are respectively red and green, the projection 306 will be blue; while when the first color barrier unit and second color barrier unit are respectively red and blue, the projection 306 will be green; so on and so forth.

As can be seen from FIG. 3, the dark lines or dark areas are mainly generated due to variation in the electric field caused by a relative displacement between two adjacent first main electrodes. Therefore, in the present embodiment, the projection 306 is preferably present only between the two sub-pixel units of each of the pixel modules. And no projection 306 is arranged between two adjacent pixel modules. Of course, in other embodiments of the present disclosure, the projection 306 can be disposed between two adjacent pixel modules also, depending on actual requirements. The present disclosure is not limited thereto.

Since the projection 306 is higher than the first pixel electrode and the second pixel electrode, while being used, the liquid crystal in the liquid crystal display panel close to the projection 306 will be tilted toward both sides of the projection 306, so that the liquid crystal can achieve a better alignment effect. This will reduce or even eliminate the dark lines or dark areas appearing in the display of the existing array substrate, thereby improving the effects of visual experience.

The present embodiment further provides a liquid crystal display panel using the array substrate as described above.

As can be seen from the above description, according to the array substrate provided in the present embodiment, the projection can be arranged to physically stabilize the tilt angle of the liquid crystal around the projection, so as to reduce or even eliminate the dark lines or dark areas appearing in the display of the existing array substrate. The effects of visual experience can thus be improved.

It could be understood that, the embodiments disclosed herein are not limited by the specific structures or materials disclosed herein, but incorporate the equivalent substitutes of these features which are comprehensible to those skilled in the art. It could be also understood that, the terms used herein are used for describing the specific embodiments, not for limitation.

The phrases “one embodiment” or “embodiments” referred to herein mean that the descriptions of specific features, structures and characteristics in combination with the embodiments are included in at least one embodiment of the present disclosure. Therefore, the phrases “one embodiment” or “embodiments” that have appeared in different parts of the whole description do not necessarily refer to the same embodiment.

The embodiments are described hereinabove to interpret the principles of the present disclosure in one application or a plurality of applications. However, a person skilled in the art, without departing from the principles and thoughts of the present disclosure, can make various modifications to the forms, usages, and details of the embodiments of the present disclosure without any creative work. Therefore, the scope of the present disclosure shall be determined by the claims.

1. An array substrate, comprising: a plurality of data lines, a plurality of scan lines, and a plurality of sub-pixel units formed by the plurality of data lines and the plurality of scan lines in a staggered arrangement, two adjacent sub-pixel units forming a pixel module,
wherein the pixel module comprises:
a color barrier layer, including a first color barrier unit and a second color barrier unit respectively formed in the two adjacent sub-pixel units, a color barrier interface between the first color barrier unit and the second color barrier unit being formed above the data lines;
a pixel electrode layer, including a first pixel electrode and a second pixel electrode that are formed on the color barrier layer, the first pixel electrode and the second pixel electrode respectively corresponding to the first color barrier unit and the second color barrier unit; and
a projection formed directly above the color barrier interface, so as to effect a reliable alignment of a liquid crystal close to the projection.

2. The array substrate according to claim 1, wherein the first pixel electrode comprises:
a first main electrode and a second main electrode, wherein the first main electrode is parallel and close to a first side of the first sub-pixel unit, and the second main electrode is perpendicular to the first main electrode, and
a plurality of branch electrodes, wherein one end of each of the branch electrodes is connected to at least one of the first main electrode and the second main electrode.

3. The array substrate according to claim 2, wherein the first main electrode and the second main electrode divide the pixel electrode layer into a plurality of display regions and a plurality of branch electrodes located in a same display region are parallel to each other.

4. The array substrate according to claim 1, wherein the first pixel electrode and the second pixel electrode are symmetrical with respect to the projection.

5. The array substrate according to claim 1, wherein the projection has a greater height than the pixel electrode layer.

6. The array substrate according to claim 1, wherein the projection has a different color from the first color barrier unit and the second color barrier unit.

7. The array substrate according to claim 2, wherein the projection has a different color from the first color barrier unit and the second color barrier unit.

8. The array substrate according to claim 1, wherein the projection is in the shape of a strip and parallel with the data lines.

9. The array substrate according to claim 1, wherein the first color barrier unit and the second color barrier unit partially overlap each other above the data lines.

10. The array substrate according to claim 1, wherein the first pixel electrode and/or the second pixel electrode are flexible electrodes.

11. A liquid crystal display panel, comprising an array substrate, which includes a plurality of data lines, a plurality of scan lines, and a plurality of sub-pixel units formed by the plurality of data lines and the plurality of scan lines in a staggered arrangement, two adjacent sub-pixel units forming a pixel module,
wherein the pixel module comprises:
a color barrier layer, including a first color barrier unit and a second color barrier unit respectively formed in the two adjacent sub-pixel units, a color barrier interface between the first color barrier unit and the second color barrier unit being formed above the data lines;
a pixel electrode layer, including a first pixel electrode and a second pixel electrode that are formed on the color barrier layer, the first pixel electrode and the second pixel electrode respectively corresponding to the first color barrier unit and the second color barrier unit; and
a projection formed directly above the color barrier interface, so as to effect a reliable alignment of a liquid crystal close to the projection.

12. The liquid crystal display panel according to claim 11, wherein the first pixel electrode comprises:
a first main electrode and a second main electrode, wherein the first main electrode is parallel and close to a first side of the first sub-pixel unit, and the second main electrode is perpendicular to the first main electrode, and
a plurality of branch electrodes, wherein one end of each of the branch electrodes is connected to at least one of the first main electrode and the second main electrode.

13. The liquid crystal display panel according to claim 12, wherein the first main electrode and the second main electrode divide the pixel electrode layer into a plurality of display regions and a plurality of branch electrodes located in a same display region are parallel to each other.

14. The liquid crystal display panel according to claim 11, wherein the first pixel electrode and the second pixel electrode are symmetrical with respect to the projection.

15. The liquid crystal display panel according to claim 11, wherein the projection has a greater height than the pixel electrode layer.

16. The liquid crystal display panel according to claim 11, wherein the projection has a different color from the first color barrier unit and the second color barrier unit.

17. The liquid crystal display panel according to claim 12, wherein the projection has a different color from the first color barrier unit and the second color barrier unit.

18. The liquid crystal display panel according to claim 11, wherein the projection is in the shape of a strip and parallel with the data lines.

19. The liquid crystal display panel according to claim 11, wherein the first color barrier unit and the second color barrier unit partially overlap each other above the data lines.

20. The liquid crystal display panel according to claim 11, wherein the first pixel electrode and/or the second pixel electrode are flexible electrodes.
